(19) United States
(12) Patent Application Publication
(10) Pub. No.: US 2022/0383255 A1
(43) Pub. Date: Dec. 1, 2022

(54) Method and Apparatus for Capturing Shipping Bills of Lading

(71) Applicant: DDC Holdings, LLC, Evergreen, CO (US)

(72) Inventors: Jan Trevalyan, Ormskirk, West Lancs (GB); Jericho Petilla, Mandaluyong City (PH)

(21) Appl. No.: 17/770,154

(22) PCT Filed: Nov. 13, 2020
(86) PCT No.: PCT/US2020/060386

§ 371 Date: Apr. 19, 2022

Related U.S. Application Data
(60) Provisional application No. 62/935,402, filed on Nov. 14, 2019.

(51) Int. Cl. G06Q 10/08

(52) U.S. Cl. CPC G06Q 10/0875

(57) ABSTRACT

An apparatus for processing a bill of lading (104) for use by a client that includes a scanner (106) configured to scan the bill of lading (104) to generate a bill of lading image (156). A neural network (108) receives the image (156) and is trained to recognized units of information contained on the bill of lading image (156) and to assign each unit of information to one of a plurality of standardized data fields based on selected criteria. A processor (103) generates a graphical user interface (150) showing data boxes (154) corresponding to the standardized data fields and populates the data boxes with corresponding the units of information assigned to each of the standardized data fields. The scanned image is displayed on a display (101) next to the graphical user interface. The graphical user interface and the scanned image (156) are transmitted to the client (12).

### CROSS-REFERENCE TO RELATED APPLICATION(S)

This application claims the benefit of US Provisional Patent Application Serial No. 62/935,402, filed Nov. 14, 2019, the entirety of which is hereby incorporated herein by reference.

### BACKGROUND OF THE INVENTION

### 1. Field of the Invention

The present invention relates to document processing systems and, more specifically, to a system for processing bills of lading automatically.

### 2. Description of the Related Art

A bill of lading (BOL) is a document issued by a carrier (or a carrier's agent) to acknowledge receipt of cargo for shipment once the goods have been loaded onto the vessel. This receipt can be used as proof of shipment for customs and insurance purposes, and also as commercial proof of completing a contractual obligation. Bills of lading are one of three crucial documents used in international trade to ensure that exporters receive payment and importers receive the merchandise. The other two documents include an insurance policy and an invoice. A bill of lading serves three main functions, including: acting as an acknowledgement that the goods have been loaded; evidencing the terms of the contract of carriage; and documenting title to the goods.

A BOL is a legal document that has to be filled out before a freight shipment is hauled. Having this document signed protects the carrier and the shipper because it contains detailed information about the quantity, type, and destination of whatever is being shipped. The BOL is traditionally issued by a carrier and then given to the person shipping the goods.

There are five types of BOLs: order BOL, straight BOL, claused BOL, electronic BOL, and negotiable BOL. An order BOL can be transferred to a third party if it's endorsed correctly. A straight BOL is non-negotiable and used only when the goods don't require payment or have already been paid for. A claused BOL is only required when the goods have been damaged prior to delivery. An electronic BOL is simply a paperless BOL. A negotiable BOL can be transferred to someone else after its endorsed and delivered to a different consignee.

Different carriers often have their own formats for bills of lading, often with different field names and fields being placed at different positions on the bill. Some bills of lading include handwritten entries into fields, whereas some are entered with computers or typewriters. In some applications, data from bills of lading are transferred electronically for various uses.

The information from bills of lading is usually transcribed into a digital format to facilitate quick transfer of information. This is frequently done manually, which can be time consuming, costly and can result in errors. Some errors are due simply to incorrectly entered data and to typographical errors; some errors result from the different formats for bills of lading supplied by different carriers; and some errors are due to misperception/misunderstanding by the transcriber. Regardless of the type of error, such errors can have substantial consequences, both to the carrier and to the buyer of the goods.

Supply chain operations frequently fall victim to destructive errors in the billing process, which can be widespread and often experienced repeatedly within a single organization. These data discrepancies may seem insignificant out of context, but they often cause undetected leaks in revenue that put a client satisfaction, brand reputation, and bottom line at risk.

The most common types of billing errors include: (1) Consignee address errors, in which the shipper's consumers have entered the wrong city, state or zip code. This error is even more likely when end-users shop on a mobile app with an auto-populating feature, in which they store more than one shipping address. (2) Incorrect selection of the correct freight term (e.g., prepaid or collect). If the freight term is incorrect or not clearly stated on the BOL, it will be delivered to the incorrect consignee, causing issues for all stakeholders in the supply chain. In addition to jeopardizing the relationship with the customers (and likewise between them and their buyers), an incorrect freight term may have major implications on the inbound cashflow. Two terms are typically used to describe who pays for a specific freight shipment: Prepaid: When a shipment is moved prepaid, the consignor or shipper, pays the freight bill for the shipment it is moving for its customer, then charges its customer after delivery; and Collect: When a shipment is moved collect, the receiver of the shipment is responsible for paying the freight delivery service. The receiver is often called the consignee. In order to avoid delivery and accounts receivable interruptions, it's equally important that the correct freight term is used when capturing the BOL in the bill entry system. (3) National motor freight classification (NMFC) errors The classification system for transported materials may be standardized by the National Motor Freight Traffic Association (NMFTA), but that doesn't mean it's always entered correctly. With 18 separate classes being assigned a cost of shipping, mistakes are likely to happen. Freight class is determined by density, stowability, ease of handling and liability. The NMFC code must always be listed on the BOL. If it is not listed, there is a good possibility that your shippers' freight will have to be reclassified. Sub-NMFC codes which are denoted with a dash after the code must match the correct freight class. Inaccurate descriptions of the items being shipped can lead to dangerous situations and extreme inefficiencies. Proper classification can influence your profitability. (4) Inaccurate number of pieces and total weight, which can result when customers approximate the weight of their shipment and it ends up being incorrect. This can result in the freight having to be reweighed. Reweigh occurs when the weight on the BOL does not match the scaled weight and will likely lead to a series of delays. The shipment is typically priced out by analyzing the dimensional weight or gross weight. A shipper can charge the lighter items by dimension, as their dimensional weight is greater than actual weight. This is calculated by multiplying the length, width and height in inches and dividing it by various factors to ultimately determine the cubic weight of a given shipment. Alternatively, a shipper may charge per gross weight, which is meant for heavier items. (5) Overlooked discounted rates, in which discounts are not properly applied to the BOL. Shippers often take advantage of any sort of discounts that they can claim for processing their shipment. It's important that they watch for and honor the discounts that apply. This will help all parties maintain confidence levels in the reflected rates and prevent delays. These inaccuracies will impact your profitability.

Therefore, there is a need for system for capturing bill of lading data in an electronic format that recognizes data from a plurality of different bill of lading formats.

There is also a need for a method of recognizing bill of lading information from a variety of bill of lading formats and automatically assigning the information to a graphical representation of a client-specific bill of lading format.

### SUMMARY OF THE INVENTION

The disadvantages of the prior art are overcome by the present invention which, in one aspect, is a system for capturing bill of lading data automatically and for storing such data in a predetermined organizational scheme.

In another aspect, the invention is an apparatus for processing a bill of lading for use by a client that includes a scanner configured to scan the bill of lading so as to generate a bill of lading image. A neural network receives the bill of lading image from the scanner. The neural network is trained to recognized units of information contained on the bill of lading image and to assign each unit of information to one of a plurality of standardized data fields based on selected criteria. A processor is in data communication with the scanner and is configured to: generate a graphical user interface showing data boxes corresponding to the standardized data fields and populate the data boxes with corresponding the units of information assigned to each of the plurality of standardized data fields; display the scanned image on a display next to the graphical user interface; and transmit the graphical user interface and the scanned image to the client. The selected criteria can include content values of each unit of information. The neural network is trained to recognize a bill of lading format and the selected criteria can include a location of each unit of information. The neural network can include a convolutional neural network.

In yet another aspect, the invention is a method of managing bills of lading used by a client, in which a neural network is trained to classify bill of lading data based on selected criteria. A bill of lading is scanned with a scanner so as to generate a scanned image of the bill of lading. The scanned image of the bill of lading is received from the scanner. The scanned image of the bill of lading is applied to the neural network, which recognizes data units on the scanned image of the bill of lading and assigns the data units to standard data fields. Data boxes in a graphical user interface that each correspond to the standardized data fields are populated with data units corresponding to the standard data fields. The standard data fields are arranged in the graphical user interface into a data format employed by the client. The data in the format employed by the client are transmitted to an application program interface of the client.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing one embodiment of an apparatus for capturing shipping bills of lading.

FIG. 2 is a flow chart showing one embodiment of a method for capturing shipping bills of lading.

FIG. 3A-3E are a schematic diagrams showing screens presented to a user at different phases of execution of the method for capturing shipping bills of lading.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Also, as used herein, “global computer network” includes the Internet.

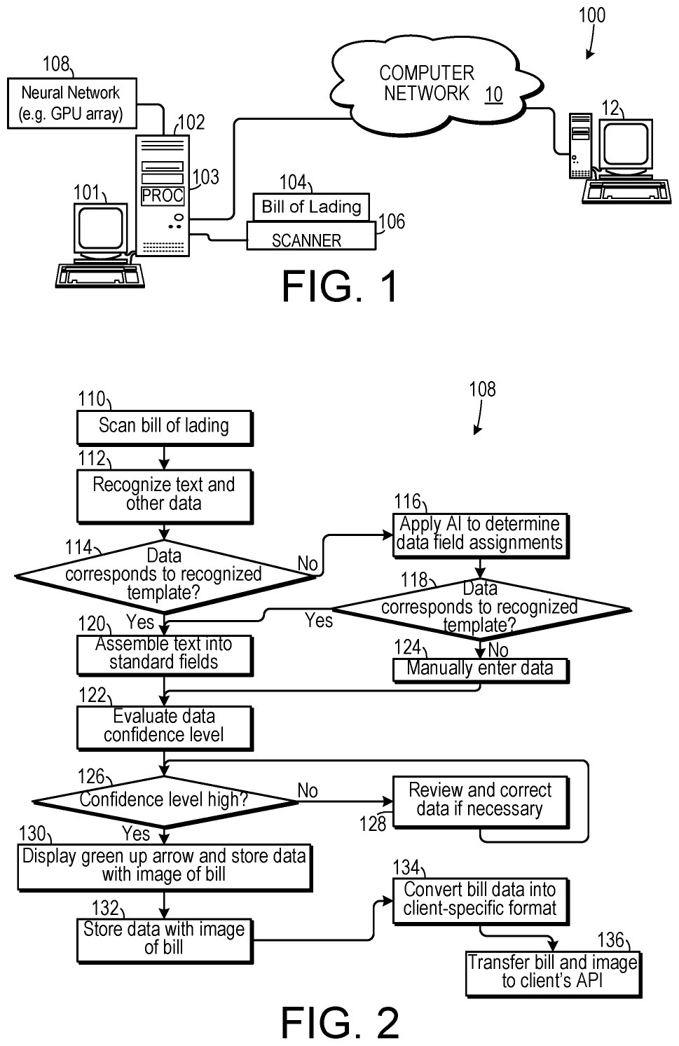

As shown in FIG. 1, one embodiment of a system for processing a bill of lading 100 includes a central computer system 102, which includes a processor 103, a volatile memory and a tangible non-volatile memory and a display 101. The computer system 102 is coupled to a scanner 106 that is configured to scan bills of lading 104 and at least one client computer 12. The computer system 102 is in data communication with a deep learning neural network 108. Both the central computer 102 and the client computer 12 are configured to communicate with each other via a global computer network 10. The neural network 108 can include a convolutional neural network and can be embodied in one or more graphics processing units (GPUs), such as an array of GPUs. One example of a suitable neural network 108 unit includes a stand-alone artificial intelligence workstation, such as an NVIDIA DGX System.

As shown in FIG. 2, in one embodiment of a method 108 for processing a bill of lading, at least one bill of lading is scanned 110 with the scanner and the central computer system employs an optical character recognition (OCR) routine to recognize text and other data 112 from the bill of lading. An artificial intelligence (AI) engine determines if the data corresponds to a known bill of lading template (i.e., a bill of lading template typically used by a major shipping company) 114. If it does not, then an AI engine is applied to the data to determine the most likely data field assignments for the data 116 and the system then determines if the data now corresponds to a recognized template 118. Once correspondence is found between the data and a known template, the text and other data is assembled into standard data fields 120. If no correspondence is determined, then the data is entered manually 124 into the standard data fields. The system is configured to learn from previously-scanned bills of lading so that as more bills of lading are processed, more input formats become recognizable.

The confidence in the data is evaluated 122 and a confidence level is assigned to the data taken from the scanned bill of lading. For example, if data recognition step 112 shows no errors and if all of the data fits into a known template and if all of the data values are within expected ranges and are of the correct type, then the confidence level assigned is high. On the other hand, if these conditions are not met, then the confidence level assigned is low. When the confidence level is not determined to be high 126 then the data is reviewed and corrected 128. This may be done automatically in certain situations or manually if necessary. The neural network may also generate a confidence level based on the amount of convergence between the images on the scanned bill of lading and the stored image elements in the trained network.

A screen then displays all of the data with the standardized fields, along with an image of the scanned bill of lading. This allows easy data verification by a user on one screen. An indicator (such as a green up arrow) is displayed next to data fields having a high confidence level 130. The standardized data and the image of the bill of lading are stored 132 in a non-volatile computer-readable medium.

The bill of lading data can then be converted into a client's specific format 134. The data and the bill image can then be transferred to the client's application program interface (API) 136. Thus, when a client employs a standard format that is different from that of a shipper, the system can deliver the data to the client in the format desired by the client.

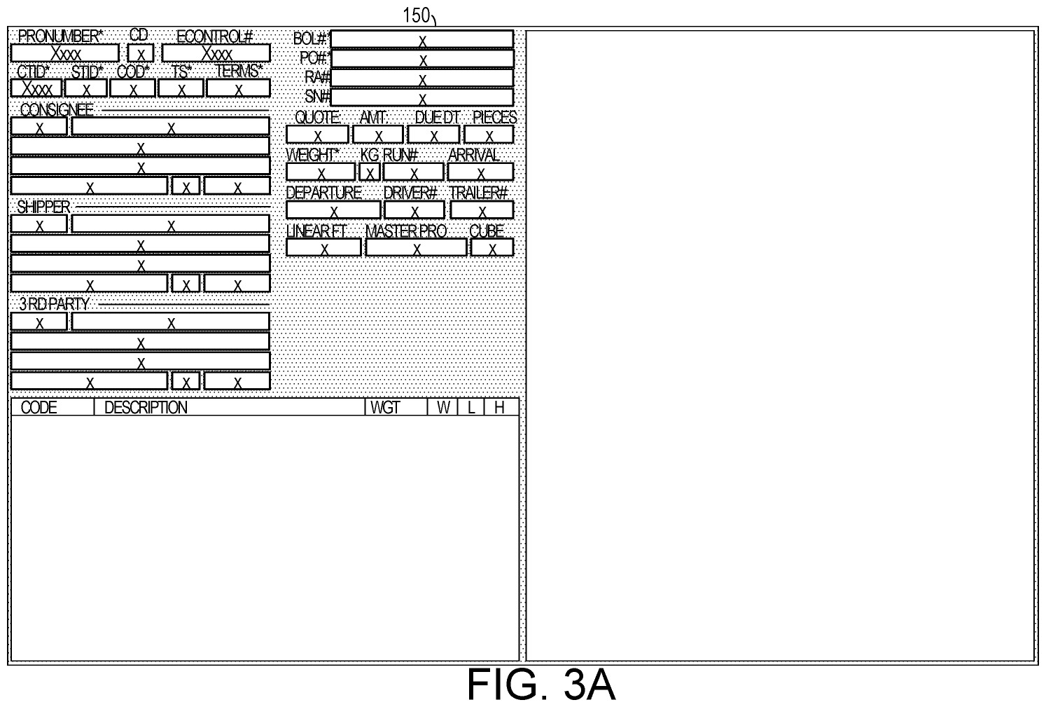

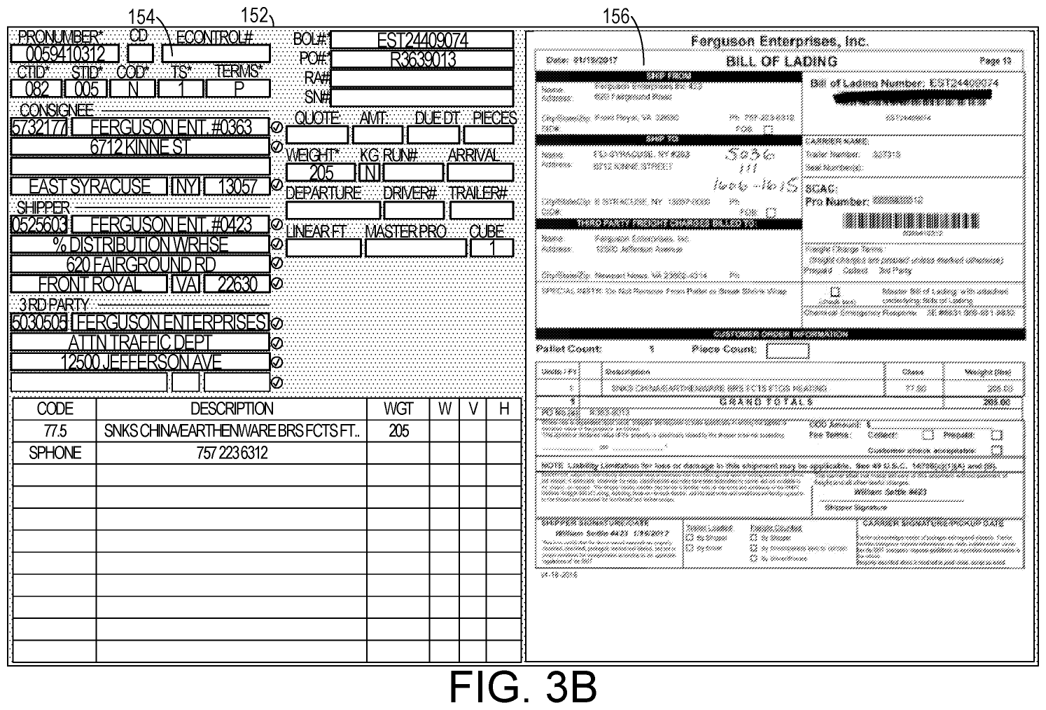

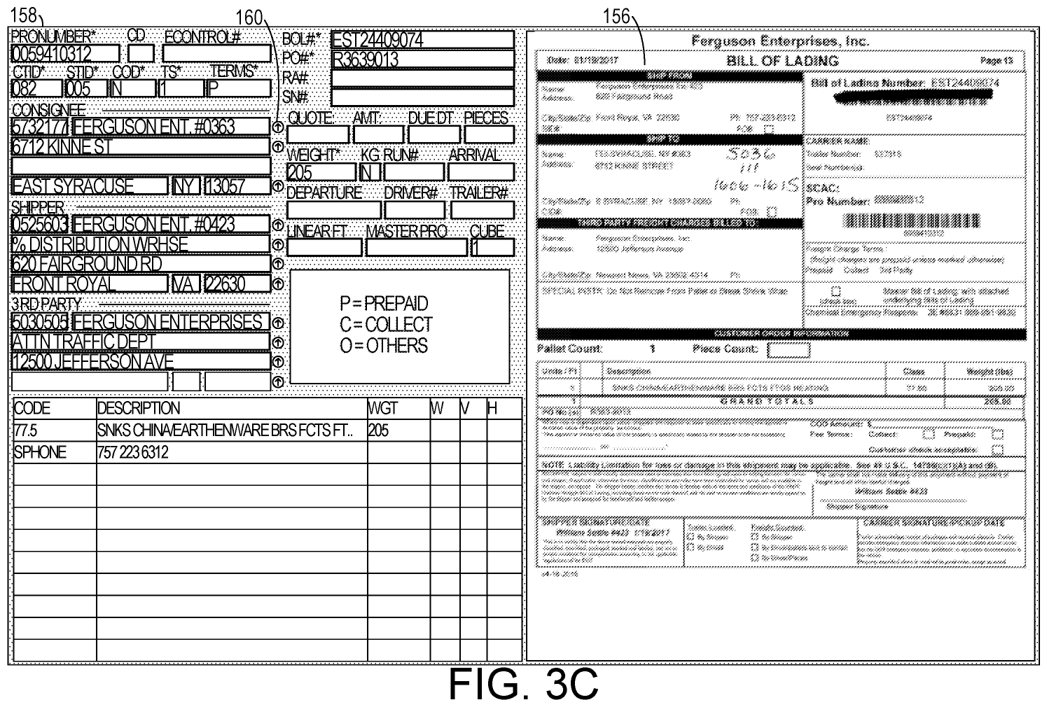

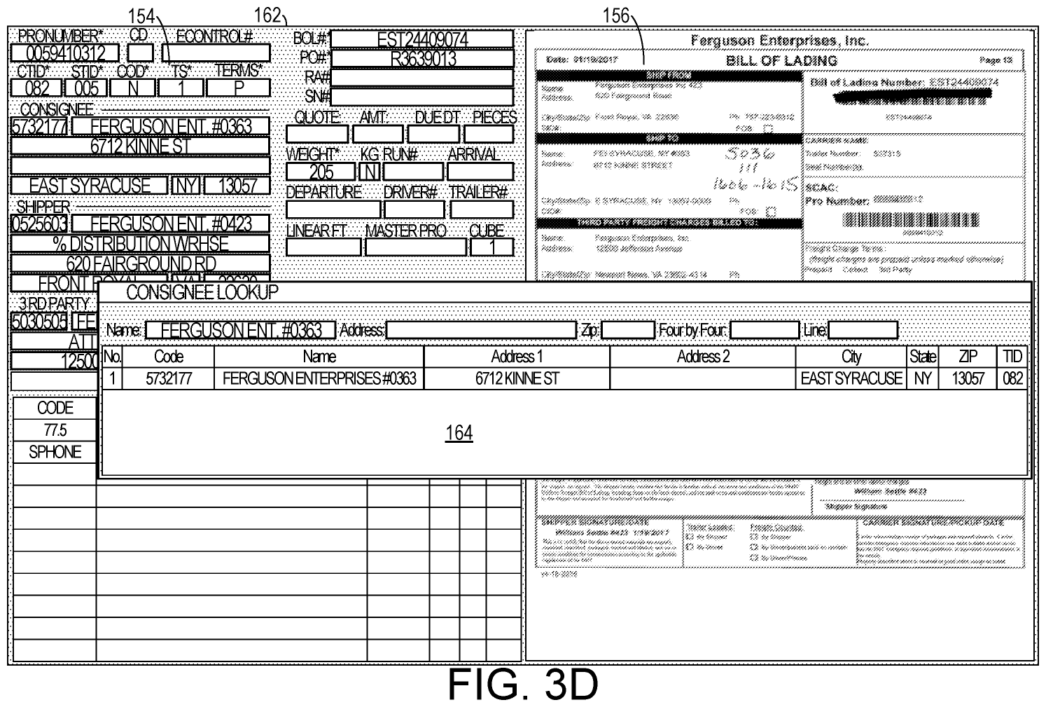

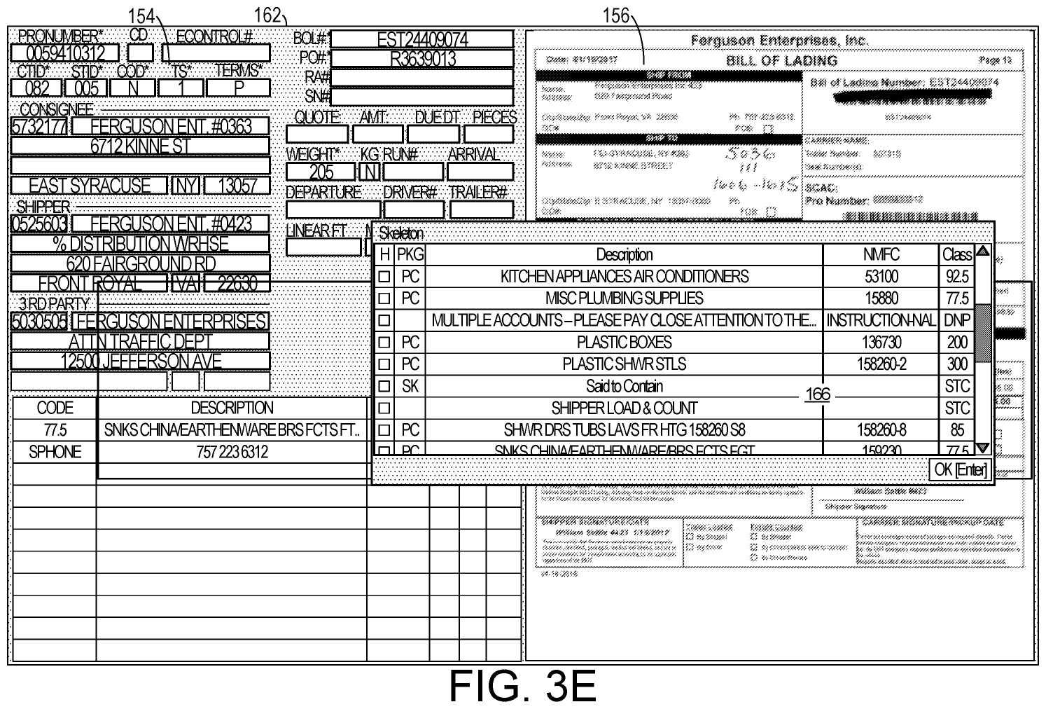

A user interface 150 has an entry screen with a standard data template is shown in FIG. 3A. As shown in FIG. 3B, once a bill of lading is scanned, the screen 152 populates the data into data boxes 154 of a standard format and the scanned bill of lading 156 is also displayed. As shown in FIG. 3C, confidence level indicators 160 are displayed on the populated screen 158. As shown in FIG. 3D, from the screen 162, the user can click on various fields to look up more details about various data fields and can display them in popup windows, such as a lookup for details about a consignee 164. As shown in FIG. 3E, one can click open a popup window to view details of a shipment 166, such as a listing of items being shipped.

In summary, data is received from any partner-preferred source, including scan, email, fax and in any format including TIF, PDF, DOC and XLS—(and many other formats known to the shipping industry). Documents are classified based on content, reducing manual sorting at scan time. Field and line-item data is extracted (usually at 80% to 90% accuracy) without templates, keywords or scripted rules. Extracted information is reconciled against known sources to ensure accuracy and validity independent of misspellings and OCR errors. Indexing information and extracted data are seamlessly exported and integrated into any partner-preferred enterprise application and architecture without disrupting business processes. Essentially, the system abandons traditional rules-based approaches to billing with an unstructured, context recognition program that literally grows smarter with every bill of lading that it processes.

One embodiment employs an AI-powered, full-stack software-as-a-service (SaaS) solution that is designed to streamline the manual billing process with accuracy rates and processing speeds that multiply revenue and expedite the accounts receivable. This embodiment includes a combination of template-based, template-free and hands-on expert question-and-answer processes to equip the shipper with a smarter, stronger, and more strategic back office. The machine-learning characteristics of the solution enable it to read and capture any bill of lading (BOL) and to learn classifications the system's neural network is trained through processing BOLs.

The invention offers improved accuracy of the bill entry process; quicker BOL data entry; efficient preparation for clean, collectible invoices; standardization that allows for quality metrics to be met' immediate cost containment and long-term savings; and customized adaptability to integrate seamlessly into your billing process workflows. It results in customizable field capture of any BOL from any BOL format. It has the ability to default third-party based on shipper id & terms. The field edits/format/instructions specific to customers can be customized. It includes an in-cab or terminal short bill process and it captures skeleton data. It provides short cut keys to reduce lag time and improve data entry speed. Its customizable performance enhancements can be built to specific user's needs.

In one example of a typical ‘Freight Bill Entry Solution’ using DDC Intelligence, a document image is received from one of any partner-preferred sources, such as: FTP, email, and fax and in any format, including TIF,PDF,DOC and XLS. The document is classified based on content, reducing manual sorting at scan time. Field and line-item data are extracted from the document and automatically populated into the proper fields. Extracted information is reconciled against known sources to ensure accuracy and validity independent of misspellings and OCR errors. The data output is seamlessly exported and integrated into any partner-preferred enterprise application and architecture without disrupting business processes.

One example is DDC Intelligence, which “leverages machine-learning software to eliminate manual data entry by automatically extracting and validating data. Because of its neural network, it has the capability to read and understand context, which results in it becoming smarter and more accurate with each document. As a result, one embodiment can automate up to 80% of the data capture process, which dramatically reduces labor expenses and increases throughput.

If the pickup or drop-off location is in an area with limited access, certain penalties can be applied automatically by the system. Limited access areas can include, for example: camps, places of worship, educational institutions, construction sites, businesses located outside of city limits, rural locations, etc. If an employee of a commercial business is not open to the public or is unable to assist with loading/unloading, this is also considered limited access for which the system can automatically apply penalties. The invention helps to ensure that all information is captured in a billing system correctly to mitigate the risk of delays, avoid conflict with customers and help the user to get paid quickly.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An apparatus for processing a bill of lading for use by a client, comprising:
(a) a scanner configured to scan the bill of lading so as to generate a bill of lading image;
(b) a neural network, which receives the bill of lading image from the scanner, that is trained to recognized units of information contained on the bill of lading image and to assign each unit of information to one of a plurality of standardized data fields based on selected criteria; and
(c) a processor, in data communication with the scanner, configured to:
generate a graphical user interface showing data boxes corresponding to the standardized data fields and populating the data boxes with corresponding the units of information assigned to each of the plurality of standardized data fields;
(ii) display the scanned image on a display next to the graphical user interface; and
(iii) transmit the graphical user interface and the scanned image to the client.

2. The apparatus of claim 1, wherein the selected criteria include content values of each unit of information.

3. The apparatus of claim 1, wherein the neural network is trained to recognized a bill of lading format and wherein the selected criteria include a location of each unit of information

4. The apparatus of claim 1, wherein the neural network comprises a convolutional neural network.

5. The apparatus of claim 1, wherein the graphical user interface includes at least one confidence level indicator displayed next to at least one of the data boxes wherein the confidence level indicator indicates a confidence level in the designation of the unit of information in the data box generated by the neural network.

6. A method of managing bills of lading used by a client, comprising the steps of:
(a) training a neural network to classify bill of lading data based on selected criteria;
(b) scanning a bill of lading with a scanner so as to generate a scanned image of the bill of lading;
(c) receiving the scanned image of the bill of lading from the scanner;
(d) applying the scanned image of the bill of lading to the neural network thereby recognizing data units on the scanned image of the bill of lading and to assigning the data units to standard data fields;
(e) populating data boxes in a graphical user interface that each correspond to the standardized data fields with data units corresponding to the standard data fields;
(f) arranging the standard data fields in the graphical user interface into a data format employed by the client; and
(g) transmitting the data in the format employed by the client to an application program interface of the client.

6. The method of claim 6, wherein the selected criteria include content values of each unit of information.

8. The method of claim 6, wherein the neural network is trained to recognized a bill of lading format and wherein the selected criteria include a location of each unit of information

9. The method of claim 6, wherein the neural network comprises a convolutional neural network.

10. The method of claim 6, further comprising the steps of:
(a) generating a confidence level indicator that indicates a confidence level in a designation of the unit of information in the data box generated by the neural network; and
(b) displaying the confidence level indicator on the graphical user interface next to the data box.
